(19) United States
(12) Patent Application Publication
(10) Pub. No.: US 2026/0248108 A1
(43) Pub. Date: Aug. 27, 2026

(54) SYSTEM AND METHOD FOR DETERMINING LIQUID CONSUMPTION BY DOMESTIC ANIMAL FROM WATER DISPENSER

(71) Applicant: Automated Pet Care Products, LLC D/B/A Whisker, Auburn Hills, MI (US)

(72) Inventors: Jeff Skutnick, Indian River, MI (US); Brad Baxter, Bloomfield Hills, MI (US); Jason Smith, West Bloomfield, MI (US); Patrick McCormick, Clarendon Hills, IL (US); Jacob Zuppke, Bloomfield Hills, MI (US)

(21) Appl. No.: 19/165,726

(22) PCT Filed: Mar. 18, 2024
(86) PCT No.: PCT/US2024/020390

§ 371 Date: Sep. 16, 2025

Related U.S. Application Data
(60) Provisional application No. 63/490,990, filed on Mar. 17, 2023.
(60) Provisional application No. 63/490,910, filed on Mar. 17, 2023.

(51) Int. Cl. A01K 29/00; A01K 7/00; G06V 20/52; G06V 40/10

(52) U.S. Cl. CPC A01K 29/007; A01K 7/00; G06V 20/52; G06V 40/10

(57) ABSTRACT

A method for monitoring and determining consumption from a water dispenser by an animal, the method comprising: a) an animal approaching the water dispenser and coming into a view of a visual monitoring device; b) the animal consuming (e.g.. lap. swallow) a liquid from a serving area of the water dispenser; c) the visual monitoring device receiving incoming video data of the animal consuming the liquid, wherein the incoming video data includes: i) at least a portion of a face and/or neck (e.g.. mouth, tongue, cheek, neck) of the animal visually indicating the animal is consuming the liquid; ii) the surface area of the liquid in serving area; iii) an inner surface of the serving area; and/or iv) a plurality of measurement aids in the serving area; d) automatically determining an amount of the liquid consumed by the animal based on the incoming video data.

### CROSS-REFERENCE TO RELATED APPLICATIONS

This application claims priority from U.S. Provisional Application Nos. 63/490,990 and 63/490,910, filed on Mar. 17, 2023, and which are incorporated herein by reference in their entirety for all purposes.

### FIELD

The present disclosure relates to a video monitoring system. The monitoring system may be beneficial in monitoring pet behavior, including use of one or more water dispensers. The monitoring system may be advantageous in determining a level of consumption of water.

### BACKGROUND

Water dispensers for animals tend to rely on human observation for filling and cleaning. Typically, a pet owner must observe the water level in a serving bowl or holding tank to determine if additional water should be added. Pet owners may be under the impression that their animal(s) is consuming most or all of the water between refills. This presents the challenge that plain observation of water levels may not give an accurate understanding of water consumed by an animal. For example, evaporation in warmer and/or drier climates may deplete water. As another example, an animal playing with the water in a serving bowl may also deplete water.

Some automated devices for filling the needs of domestic animals and their owners often include a number of onboard sensors. These sensors may be advantageous in monitoring performance of the device itself and monitoring usage of the device by an animal. For example, the automated litter device disclosed in WO 2020/219849A1, incorporated herein by reference in its entirety for all purposes, makes use of one or more sensors near the entry opening to determine the presence of an animal entering and/or exiting the chamber and a level of litter within the chamber. As another example, the automated feeder disclosed in WO 2020/061307, incorporated herein by reference in its entirety for all purposes, makes use of a sensing tower to determine the volume of food available and one or more chute sensors to determine the level of food available for consumption. A challenge presented by these sensors is they may not be suitable for separating out consumption by an animal as compared to depletion by other external factors (e.g., temperature, low humidity, splashing). Additionally, these sensors may not be suitable for cooperating with water as a transparent liquid.

What is needed is a system which is able to detect usage of a water dispenser by an animal. What is needed is a system which is able to detect an amount of water consumed by the animal. What is needed is a system which is able to determine water depleted by external factors. What is needed is a system which is able to determine how much water remains within a water dispenser. What is needed is a system which is able to communicate to a user (e.g., pet owner) as to when they may need to refill a water dispenser. What is needed is a system which is able to communicate consumption of the animal to the user.

### SUMMARY

The present disclosure relates to a method for monitoring and determining consumption from a water dispenser by an animal, the method comprising: a) an animal approaching the water dispenser and coming into a view of a visual monitoring device; b) the animal consuming (e.g., lap, swallow) a liquid from a serving area of the water dispenser; c) the visual monitoring device capturing incoming image(s) of the animal consuming the liquid and converting the incoming image(s) to incoming image data, wherein the incoming image data includes: i) at least a portion of a face and/or neck (e.g., mouth, tongue, cheek, neck) of the animal visually indicating the animal is consuming the liquid; ii) the surface area of the liquid in serving area; iii) an inner surface of the serving area; and/or iv) a plurality of measurement aids in the serving area; d) automatically determining an amount of the liquid consumed by the animal based on the incoming image data.

The present disclosure relates to a method for monitoring and determining consumption from a water dispenser by an animal, the method comprising: a) an animal approaching the water dispenser and coming into a view of a visual monitoring device; b) the animal consuming (e.g., lap, swallow) a liquid from a serving area of the water dispenser; c) the visual monitoring device receiving incoming video data of the animal consuming the liquid, wherein the incoming video data includes: i) at least a portion of a face and/or neck (e.g., mouth, tongue, cheek, neck) of the animal visually indicating the animal is consuming the liquid; ii) the surface area of the liquid in serving area; iii) an inner surface of the serving area; and/or iv) a plurality of measurement aids in the serving area; d) automatically determining an amount of the liquid consumed by the animal based on the incoming video data.

The present disclosure relates to a method for monitoring and determining consumption from a water dispenser by an animal, the method comprising: a) an animal approaching the water dispenser and coming into a view of a visual monitoring device; b) the animal using their tongue to consume (e.g., lap) a liquid from a serving area of the water dispenser; c) the visual monitoring device receiving incoming video data of the animal consuming the liquid, wherein the incoming video data includes: i) the tongue of the animal consuming the liquid: and ii) the frequency of the tongue lapping the liquid while the animal is at the serving area; d) automatically determining an amount of the liquid consumed by the animal based on the incoming video data.

The present teachings provide for a visual monitoring system which may be able to detect usage of a water dispenser by an animal, such as by one or more visual monitoring devices. The present teachings may be able to use image data captured by one or more visual monitoring devices to detect and determine an amount of water consumed by an animal. A visual monitoring device may be useful in eliminating external environmental factors, such as temperature and humidity. The visual monitoring system with the visual monitoring device and optionally further sensors (e.g., mass sensor) may be able to determine how much water remains within various portions of water dispenser and/or anticipated refill needs. The visual monitoring system of the present teachings may be able to cooperate with various computing devices, including personal computing devices, to notify one or more users (e.g., pet owners, caregivers) of their animal's water consumption, trends, and/or deviation from trends.

### DESCRIPTION OF DRAWINGS

FIG. 1 illustrates an animal consuming water from a water dispenser of a visual monitoring system.

FIG. 2 shows an animal drinking water from a dispenser in view of a visual monitoring system.

FIG. 3 illustrates a visual monitoring system.

FIG. 4 illustrates a visual monitoring system.

FIG. 5 illustrates a front perspective of a water dispenser with a visual monitoring system.

FIG. 6 is a rear perspective view of a water dispenser without a fresh tank.

FIG. 7 illustrates a cross-section of water dispenser with a visual monitoring system.

FIG. 8 illustrates a personal computing device and various displays on its user interface related to consumption of water from a water dispenser by an animal.

FIG. 9 is a flowchart of a method for monitoring and determining consumption.

FIG. 10 illustrates an architecture of a video monitoring device.

FIG. 11 is a perspective view of a serving bowl.

FIG. 12 is a top view of a serving bowl.

FIG. 13 illustrates a pet profile database.

FIG. 14 is a flowchart of a data collection method.

FIG. 15 is a flowchart of determining liquid consumption.

FIG. 16 illustrates a sensing range of a water dispenser.

### DETAILED DESCRIPTION

The explanations and illustrations presented herein are intended to acquaint others skilled in the art with the present teachings, its principles, and its practical application. The specific embodiments of the present teachings as set forth are not intended as being exhaustive or limiting of the present teachings. The scope of the present teachings should be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

### Water Dispenser

The present teachings may relate to one or more water dispensers. The teachings may be relevant to a water dispenser which is an automated water dispenser. An automated water dispenser may be any type of dispenser which automates dispensing of water, or any other liquid, for consumption by an animal. The device may function to dispense one or more liquids, semi-solid consumables, and/or solid consumables. The terms “liquid” and “water” may be used interchangeably throughout. The device may function to provide liquid suitable for consumption by an animal. Liquid may include water, semi-liquid food, and/or the like. The device may function in one or more modes. The device may include one or more water actuation means (e.g., pump, carousel), cap assembly, valve assembly, actuator assembly, one or more tanks (e.g., fresh tank, used tank). one or more housing portions (e.g., bottom, intermediate, and top), one or more serving bowls, one or more filters, the like, or a combination thereof.

A water dispenser may be an automated liquid dispensing device as disclosed in PCT Patent Application No. PCT/US2023/016999 filed on Mar. 30, 2023 and US Provisional Patent Application No. 63/325,480 filed on Mar. 30, 2022, which are incorporated herein by reference in their entirety for all purposes. The water dispenser may include any or all of the one or more tanks, one or more carousels, cap assembly valve assembly, actuator assembly, housing portions, serving bowls, filters, sensing devices, any other components, and/or the like as disclosed therein.

The water dispenser may include one or more tanks. One or more tanks may function to retain one or more consumables, such as liquid. The liquid may be fresh liquid, used liquid, or both. The one or more tanks may include one or more fresh tanks, used tanks, or both. The water dispenser may include one or more fresh tanks and one or more used tanks. The water dispenser may include one or more fresh tanks while being free of any used tanks. One or more fresh tanks may function to store a fresh liquid, provide liquid for consumption, or both. One or more fresh tanks may be easily removable from the water dispenser. One or more fresh tanks may allow for easy filling with fresh water by a user. One or more used tanks may function to store a used liquid, store water which has had the opportunity to be consumed but was not, store liquid for later elimination from the water dispenser, or any combination thereof. One or more used tanks may be easily removable from the water dispenser. One or more used tanks may allow for easy expelling of used water stored therein. One or more tanks may cooperate with one or more reservoirs, one or more water actuation means, one or more valve assemblies, one or more actuator assemblies, the like, or any combination thereof.

The water dispenser may include or be free of a reservoir. A reservoir may provide an area for fresh, recirculated, and/or used water to be housed within the water dispenser. A reservoir may provide an area of the dispenser which cooperates with one or more tanks and one or more water actuation means. For example, a carousel may partially reside within a reservoir. One or more tanks may expel water into a reservoir, receive water from a reservoir, or both. A fresh tank may be configured to release fresh water into a reservoir. A used tank may be configured to receive used water from a reservoir.

The water dispenser may include one or more water actuation means. A water actuation means may function to transfer water from one portion of the water dispenser to another portion of the water dispenser, to dispense water into a serving bowl, to collect fresh water, to collect recirculated/used water, to dispense fresh water for consumption, to dispense recirculated water for consumption, to dispense used water for segregation and/or later elimination, the like, or any combination thereof. The one or more water actuation means may be manually activated or electronically activated. The one or more water actuation means may reside, and/or partially reside, within one or more reservoirs, fresh tanks, used tanks, serving bowls, the like, or any combination thereof. One or more water actuation means may include one or more water pumps, one or more carousels, one or more drive units, the like, or any combination thereof.

One or more water actuation means may include one or more water pumps. One or more water pumps may function to suck water up from one area of the water dispenser, transport the water within the pump. and then dispense the water into another area of the water dispenser. One or more water pumps may function to convert mechanical energy into kinetic energy to transport the water. One or more water pumps may reside, and/or partially reside, within one or more reservoirs, fresh tanks, used tanks, any holding area for water, the like, or any combination thereof. One or more water pumps may include one or more drive units. One or more water pumps may include a typical mini water pump. A water pump may include a volume pump, vane pump, or the like.

One or more water actuation means may include one or more carousels. In general, a carousel may function like a water wheel to transfer liquid from one area of the water dispenser to one or more other areas of the water dispenser. One or more carousels may rotate to receive and/or dispense fresh liquid, receive and/or dispense used liquid, or both. One or more carousels may include a plurality of tubs. The tubs may be radially arranged between an interior axis and an outer periphery. The tubs may function to collect water, dispense water, or both. The tubs may be partially submerged in a reservoir of the water dispenser during the rotation of the carousel. As the tubs are submerged, water may be collected therein. The carousel may function to transport water toward a spout for dispensing into a serving bowl, a used tank for later removal from the water dispenser, the like, or a combination thereof. One or more carousels may be rotated by one or more drive units. One or more drive units may be rotationally engaged with the one or more carousels. One or more drive units may be engaged with a track, hub, and/or the like. One or more drive units may include one or more drive sources (e.g., motor), drive shafts, gears, and/or the like.

Fresh water may be dispensed from a tank (e.g., fresh tank) via one or more actuator assemblies, valve assemblies, or both. Fresh water may be dispensed into a reservoir of the water dispenser. The one or more actuator assemblies may be actuated (e.g., engaged) or unactuated (e.g., disengaged) due to the rotation of the one or more carousels in one or more directions. In other words, the one or more carousels may be in rotational communication with the one or more actuator assemblies such that the torque from a carousel is transferred to an actuator assembly. Actuation of the one or more actuator assemblies may open and/or close one or more valve assemblies. Upon a valve assembly being opened, water may flow therethrough. The opposite is true as well: upon a valve assembly being closed, water may be prevented from flowing therethrough.

The direction of rotation of the carousel may be determined by the mode in which the device is operating. One or more modes may include a filling mode, circulating mode, emptying mode, or a combination thereof.

The water dispenser may include one or more lighting devices. One or more lighting devices may function to illuminate one or more portions of a water dispenser, attract an animal to the water dispenser, provide ambient lighting to support a visual monitoring system, or both. The one or more lighting devices may be affixed to an exterior and/or an interior of the water dispenser. The one or more lighting devices may be configured to project light onto a serving area. By illuminating a serving area, an animal may more easily see the liquid to be consumed. By illuminating a serving area, one or more sensing devices, a visual monitoring system, or both may more clearly recognize the presence of liquid, an animal, or both. The one or more lighting devices may be configured to illuminate an animal when using the device, when approaching the device, or when using the device. This may aid in visual monitoring by a visual monitoring system when there is insufficient ambient lighting. The one or more lighting devices may be mounted such as to illuminate a serving bowl, a stream of water from a spout, the face of an animal, or any combination thereof. One or more lighting devices may be any type of light suitable for illumination in close proximity to liquid and animals. One or more lighting devices may include one or more light-emitting diodes (LED). One or more lighting devices may include one or more light pipes. One or more light pipes may be inserted into, pass through, or extend beyond a spout opening, spout, spout funnel, the like, or any combination thereof. The one or more lighting devices may include or cooperate with one or more light sensors. A light sensor may detect an ambient lumen level, a reduced ambient lumen level below a predetermined lumen level, or both. A light sensor may cooperate with one or more processors to determine if a light level has been reduced below a predetermined lumen level. A light sensor may directly or indirectly direct one or more lighting devices to be turned on. One or more lighting devices may include one or more lighting elements as disclosed in PCT Patent Application No. PCT/US2023/016999 filed on Mar. 30, 2023, which is incorporated herein by reference in its entirety.

The water dispenser may include one or more sensing devices. The one or more sensing devices may function to sense a presence, a distance, an amount, or a combination thereof of liquid or other consumable within a serving bowl, a fresh tank, a used tank, a reservoir, or any combination thereof. One or more sensing devices may sense the amount and/or quality of a liquid or other consumable within the device. One or more sensing devices may sense one or more conditions of an ambient environment. One or more sensing devices may be affixed to one or more housing portions, spout covers, mounting brackets, tanks, reservoirs, covers, the like, or a combination thereof. One or more sensing devices may be located within a liquid holding area of a component or located to look into a liquid holding area of a component. One or more sensing devices may sense one or more conditions of the device. One or more sensed conditions may trigger one or more operations of one or more modes of the device. The one or more sensing devices may include one or more level measuring sensors, quality sensors, environmental sensors, identification sensors, or a combination thereof.

One or more sensing devices may include one or more level measuring sensors. One or more level measuring sensors may function to detect an amount of liquid within a portion of a water dispenser. The amount may be determined and/or correlated to a height, volume, distance, mass, and/or any other measurement. One or more level measuring sensors may include one or more mass sensors, ultrasonic level sensors, pressure sensors, radar level sensors, open channel level sensors, capacitance level sensors, the like, or a combination thereof. For example, one or more mass sensors may measure the weight/mass of liquid contained within the device or a portion of the device, the weight/mass of the device with the liquid contained therein as a whole, or both. For example, one or more mass sensors may be located at a base of the water dispenser (e.g., feet at the base, scale plate as the base), directly below a serving bowl, directly below a fresh tank, directly below a used tank, the like, or any combination thereof.

One or more sensing devices may include one or more quality sensors. One or more quality sensors may function to determine the characteristics of the liquid stored within the water dispenser. One or more quality sensors may include one or more pH sensors, temperature sensors, conductivity sensors, residual sensors, turbidity sensors, oxidation-reduction potential (ORP) sensors, chemical oxygen demand (COD) sensors, ammonia nitrogen ion sensors, the like, or a combination thereof.

One or more sensing devices may include one or more environmental sensors. The one or more environmental sensors may function to detect one or more conditions of an ambient environment in which the device is located. The one or more environmental sensors may be any sensor which measures an ambient lighting level, temperature, humidity, pressure, air quality, the like, or any combination thereof. The one or more environmental sensors may include one or more thermometers, hygrometers, barometers, the like, or any combination thereof. As an alternative to having one or more environmental sensors located therein, the water dispenser may be in communication with one or more environmental sensors. For example, via a communication module and/or one or more networks, one or more ambient conditions may be received from one or more environmental devices. The one or more environmental devices may include one or more thermostats (e.g., smart home thermostat), local weather applications, the like, or a combination thereof.

The water dispenser may include one or more identification sensors. One or more identification sensors may function to detect an animal within a proximity of the water dispenser, identify an animal within a proximity of the water dispenser, activate one or more features of the water dispenser, or any combination thereof. For example, upon detection of a specific animal (e.g., known from the identifier) within a sensing range, one or more identification sensors may cooperate with one or more processors to automatically rotate the carousel and provide for the flow of fresh and/or recirculated water through a spout and into the serving bowl. As another example, upon detection of a specific animal or identifier, correlating all actions of that animal at the water dispenser to that specific animal. An identifier may be sensed by an identification sensor upon entering a sensing range of the identification sensor. An identifier may be a tag, barcode, chip (e.g., embedded microchip), transceiver, color of a collar or other wearable on the animal, a design and/or pattern on a collar or other wearable on the animal, a transceiver, another sensors, the like, or any combination thereof. An identifier may be worn by (e.g., on or part of collar) or embedded into the animal. An identification sensor may be any type of transceiver which is able to cooperate with the identifier of the animal. The identification sensor and identifier may use Bluetooth, Wi-Fi, Radio Frequency, Near Field Communication, and/or the like to communication with one another. The identification sensor may be located anywhere on the water dispenser. The identification sensor may be located at a front of the water dispenser, above a serving bowl, below a serving bowl, near a control panel, in proximity to other electrical components, the like, or any combination thereof. By having the identification sensor closer to the serving bowl there is less risk of the head of an animal blocking a communication signal between the identification sensor and the identifier.

The water dispenser may include one or more measurement aids. One or more measurement aids may cooperate with one or more sensing devices, lighting devices, a visual monitoring system, other components of the water dispenser, or any combination thereof; may allow for easy determining of liquid consumption; or a combination thereof. One or more measurement aids may allow for one or more visual monitoring systems to quickly determine a volume (or other measurement) of water available for consumption by an animal. One or more measurement aids may include one or more marks on a serving bowl. One or more marks may be located on the interior surface of the serving bowl. One or more marks may be associated with a certain volume. For example, a serving bowl may have ten marks, each associated with one-tenth of a cup. Another measurement aid may be the geometry of the serving bowl. A serving bowl may have a tapered design. A visual monitoring system may cooperate with the serving bowl and associate the water surface at a certain diameter of the serving bowl with a certain volume contained within the serving bowl.

The water dispenser may include one or more controllers. The one or more controllers may function to receive one or more signals, transmit one or more signals, control operations of one or more components of the water dispenser, or a combination thereof. The one or more controllers may be in communication with one or more sensing devices. The one or more controllers may be adapted to receive one or more signals from the one or more sensing devices. The one or more controllers may be in communication with one or more sensing devices. The one or more controllers may be in electrical communication with one or more sensing devices. The one or more controllers may interpret one or more signals from one or more sensing devices as one or more status signals. The one or more controllers may automatically receive, interpret, and/or transmit one or more signals. The one or more controllers may automatically control one or more operations of one or more components upon receipt of one or more signals or instructions. The one or more controllers may reside within or be in communication with the water dispenser. The one or more controllers may include one or more controllers, microcontrollers, microprocessors, processors, storage mediums, circuit boards (e.g., printed circuit board, PCB), or a combination thereof. One or more suitable controllers may include one or more controllers, microprocessors, or both as described in U.S. Pat. Nos. 8,757,094 and 9,433,185 which are incorporated herein by reference in their entirety for all purposes. The one or more controllers may be in communication with and/or include one or more communication modules. The one or more controllers may include one or more processors. storage mediums (i.e., non-transitory), communication modules, and/or the like. The one or more controllers may be understood as a type of computing device.

The water dispenser may include one or more communication modules, one or more computing devices, or both. The water dispenser may be in communication with one or more networks, computing devices, visual monitoring systems, applications, and/or the like via the one or more communication modules, computing devices, or both.

The water dispenser may include, be part of, or be in communication with a visual monitoring system. The visual monitoring system may function to track the usage of the water dispenser by one or more animals, trends of one or more animals, identify one or more animals, the like, or any combination thereof. The visual monitoring system may allow for visually monitoring usage of the water dispenser, consumption from the water dispenser, the status of the water dispenser, the like, or any combination thereof. The visual monitoring system may include one or more water dispensers, one or more visual monitoring devices, one or more communication modules, one or more communication hubs, one or more computing devices, the like, or any combination thereof. The visual monitoring system may refer to one or more visual monitoring devices part of, in communication with, or both a water dispenser. The visual monitoring system may refer to one or more visual monitoring devices part of, in communication with, or both a water dispenser, one or more computing devices, one or more communication hubs, a network, and/or the like.

The visual monitoring system may include one or more visual monitoring devices. The one or more visual monitoring devices may be useful in recognizing and/or monitoring one or more animals, water dispensers, or both. The visual monitoring device may be useful for being located within one or more settings. The visual monitoring device may be temporarily, semi-permanently, and/or permanently affixed and/or located within a setting. A setting may include the environment in which the water dispenser is located, the water dispenser itself, or both. For example, a visual monitoring device may be permanently affixed to or within a water dispenser. As another example, a visual monitoring device may be temporarily or semi-permanently affixed within a room and/or water dispenser (e.g., mounted to a wall, located on a mount or stand). A visual monitoring device may be located such that one or more cameras may have line of sight on the water dispenser, one or more animals approaching the water dispenser, one or more animals using the water dispenser, or any combination thereof.

The visual monitoring device may include one or more sensing devices (e.g., cameras), sensing device connections, sensing device modules, image processing units, processors, memory storage devices, housings, applications, network connections, power supplies, the like, or any combination thereof. The one or more sensing devices may include one or more cameras or other image sensors, sound detection sensors, vibration or other touch sensors, electrical sensors. the like, or any combination thereof.

The one or more visual monitoring devices may be a camera. The camera may be a video camera. The one or more sensing devices may be configured to sense the presence of an animal at the water dispenser, consumption of liquid from the water dispenser, the departure of the animal from the water dispenser, the like, or any combination thereof. The one or more sensing devices may be configured to visually sense, audibly sense, tactilely sense, electrically sense the animal, the like, or any combination thereof.

The one or more sensing devices may visually detect and capture the presence, use, and/or consumption by the animal, one or more conditions of liquid in a serving bowl, one or more conditions of a serving bowl, the like, or any combination thereof. One or more sensing devices may include one or more image sensors. For example, one or more image sensors may visually capture an animal coming into view, one or more bodily motions associated with consumption or use, capture a change in volume, or any combination thereof. For example, one or more image sensors may visually capture and/or detect the cleanliness, or lack thereof, of water in a serving bowl (e.g., detecting floating contaminants). For example, one or more image sensors may visually capture and/or detect the cleanliness or lack thereof of one or more surfaces of a serving bowl (e.g., detecting one or more substances on a serving bowl which are not the liquid intended to be in the serving bowl). One or more suitable image sensors or cameras and their respective properties are discussed hereinafter.

The one or more sensing devices may audibly detect and capture the presence of, use by, and/or consumption by the animal. One or more sensing devices may include one or more sound detection sensors. For example, one or more sound detection sensors may sense and/or record a lapping sound, swallowing sound, licking sound, the like, or a combination thereof. One or more sound detection sensors may include one or more microphones, sound detection sensor modules, or the like. Exemplary sound detection sensors may include the Stemedu LM393 Sound Sensor Module, KY-037 Sound Detection Sensor, Arduino Sound Sensor Module 3-5.5V DC, all of which are incorporated herein by reference in their entirety.

The one or more sensing devices may tactilely detect the presence of, use by, and/or consumption by the animal. One or more sensing devices may include one or more vibration or other touch sensors. For example, the one or more vibration or other touch sensors may sense vibrations or taps on a serving bowl associated with consuming liquid and/or food from the device. Exemplary vibration or other touch sensors may include the Vibration Module Item #9SIB33YHE25928 available by newegg. com, SW-420 vibration module available by allelectronics. com, both of which are incorporated herein by reference in their entirety.

The one or more sensing devices may electrically detect and capture the presence of, use, and/or consumption by the animal. One or more sensing devices may include one or more electrical resistance sensors, electrical capacitance sensors, or both. Electrical detection may include noticing a change in electrical resistance, electrical capacitance, or both. For example, an electrical resistance sensor, an electrical capacitance sensor, or both may detect a change in resistance and/or capacitance when an animal is consuming liquid and/or food from a serving bowl.

One or more sensing devices may include one or more cameras (e.g., camera modules). One or more cameras may be one or more image sensors. The one or more cameras may be suitable for capturing one or more videos, images, frames, the like, or any combination thereof. The one or more cameras may be positioned within a setting to have a line of sight on at least part of a water dispenser, animals, or both. Line of sight may mean the camera is in view of at least part of or all of a front or side of a water dispenser, a serving bowl of a water dispenser, an animal when using a water dispenser, or any combination thereof. Line of sight may mean having an animal's body, side profile, head, legs, eyes, nose, mouth, ears. or any combination thereof in view of the camera. One or more cameras may be included as part of a water dispenser. One or more cameras may be partially located inside of a water dispenser. One or more cameras may be mounted on a front of a water dispenser. One or more cameras may be mounted above a serving bowl of a water dispenser. As an alternative to being part of or mounted on a water dispenser, one or more cameras may be located in a setting shared with a water dispenser (e.g., same room) and be positioned to have a line of sight to a front and/or serving bowl of a water dispenser.

The one or more cameras may have a wide-angle lens (e.g., viewing angle of 150 degrees or greater). The one or more cameras may be capable of capturing static images, video recordings, or both at resolutions of about 480 pixels or greater, 640 pixels or greater, 720 pixels or greater, or even 1080 pixels or greater. The one or more cameras may be able to capture video recordings at a frame rate of about 25 frames per second or greater, about 30 frames per second or greater, about 60 frames per second or greater, or even 90 frames per second or greater. An exemplary camera for use with the visual monitoring device may include the SainSmart IMX 219 Camera Module with an 8MP sensor and 160-degree field of vision, the camera module and its specifications are incorporated herein by reference for all purposes.

The visual monitoring device may include one or more image processing units. One or more image processing units may function to receive, process, transmit image data. or any combination thereof; store image data; or both. The one or more image processing units may include one or more processors, memory storage devices, circuit boards, the like, or any combination thereof. The one or more image processing units may include one or more central processing units, graphics processing units, memory mediums, storage mediums, the like, or any combination thereof. The one or more image processing units may include an electronic circuit board or similar. The electronic circuit board may house and place one or more processing units and memory storage devices in communication with one another. The electronic circuit board may be in communication with one or more cameras, power supply sources, network connections, the like, or any combination thereof. The electronic circuit board may be located within a housing of a visual monitoring device, within the water dispenser separate from the image device, or both. The electronic circuit board may be housed in a same or different housing as one or more sensing devices.

The water dispenser, visual monitoring system, or both may include one or more communication modules. The one or more communication modules may allow for the one or more devices to receive and/or transmit one or more signals from one or more computing devices, be integrated into a network, or both. The one or more communication modules may have any configuration which may allow for one or more data signals from one or more controllers to be relayed to one or more other controllers, communication modules, communication hubs, networks, computing devices, processors, the like, or any combination thereof located external of the water dispenser. The one or more communication modules may include one or more wired communication modules, wireless communication modules, or both. A wired communication module may be any module capable of transmitting and/or receiving one or more data signals via a wired connection. One or more wired communication modules may communicate via one or more networks via a direct, wired connection. A wired connection may include a local area network wired connection by an ethernet port. A wired communication module may include a PC Card, PCMCIA card, PCI card, the like, or any combination thereof. A wireless communication module may include any module capable of transmitting and/or receiving one or more data signals via a wireless connection. One or more wireless communication modules may communicate via one or more networks via a wireless connection. One or more wireless communication modules may include a Wi-Fi transmitter, a Bluetooth transmitter, an infrared transmitter, a radio frequency transmitter, an IEEE 802.15.4 compliant transmitter, the like, or any combination thereof. A Wi-Fi transmitter may be any transmitter complaint with IEEE 802.11. A communication module may be single-band, multi-band (e.g., dual-band), or both. A communication module may operate at 2.4 Ghz, 5 Ghz, the like, or a combination thereof. A communication module may communicate with one or more other communication modules, computing devices, processors, or any combination thereof directly; via one or more communication hubs, networks, or both; via one or more interaction interfaces; or any combination thereof.

The water dispenser, visual monitoring system, or both may include and/or be in communication with a communication hub. A communication hub may function to receive one or more signals, transfer one or more signals, or both from one or more other computing devices. The communication hub may be any type of communication hub capable of sending and transmitting data signals over a network to one or a plurality of computing devices. The communication hub may include a wired router, a wireless router, an antenna, a satellite, or any combination thereof. For example, an antenna may include a cellular tower. The communication hub may be connected to the one or more devices, one or more computing devices, or both via a wired connection, wireless connection, or a combination of both. For example, the communication hub may be in wireless connection with the visual monitoring device via the communication module. The communication hub may allow for communication of a computing device with the water dispenser when the computing device is directly connected to the communication hub, indirectly connected to the communication hub, or both. A direct connection to the communication hub may mean that the computing device is directly connected to the communication hub via a wired and/or wireless connection and communicates with water dispenser through the communication hub. An indirect connection to the communication hub may mean that a computing device first communicates with one or more other computing devices via a network before transmitting and/or receiving one or more signals to and/or from the communication hub and then to the water dispenser.

The water dispenser, visual monitoring system, or both may be integrated into one or more networks. The water dispenser, visual monitoring system, or both may be in removable communication with one or more networks. The one or more networks may be formed by placing one or more devices of the visual monitoring system in communication with one or more other computing devices. One or more networks may include one or more communication hubs, communication modules, computing devices, pet health devices, or a combination thereof as part of the network. One or more networks may be free of one or more communication hubs. One or more computing devices of the system may be directly connected to one another without the use of a communication hub. For example, a communication module of the visual monitoring device may be placed in direct communication with a communication module of a pet health device or other computing device without having a communication hub therebetween. One or more networks may be connected to one or more other networks. One or more networks may include one or more local area networks (LAN), wide area networks (WAN), intranet, Internet, Internet of Things (IOT), the like, or any combination thereof. The network may allow for the water dispenser to be in communication with one or more user interfaces remote from the device via the Internet, such as through one or more managed cloud services. An exemplary managed cloud service may include AWS IoT Core by Amazon Web Services®). The network may be temporarily, semi-permanently, or permanently connected to one or more computing devices, pet health devices, monitoring devices, or any combination thereof. A network may allow for one or more computing devices to be temporarily and/or permanently connected to the visual monitoring device to transmit one or more data signals to the water dispenser, receive one or more data signals from the device, or both. The network may allow for one or more signals from one or more controllers to be relayed through the system to one or more other computing devices, processors, storage mediums, the like, or any combination thereof. The network may allow for one or more computing devices to receive one or more data entries from and/or transmit one or more data entries to one or more storage mediums. The network may allow for the transmission of one or more signals, status signals, data entries, instruction signals, or any combination thereof for processing by one or more processors.

The water dispenser, visual monitoring system, or other components may include and/or be in communication with one or more computing devices. The one or more computing devices may function to receive and/or transmit one or more signals, convert one or more signals to data entries, to send one or more data entries to a storage medium, to store one or more data entries, to retrieve one or more data entries from a storage medium, to compute one or more algorithms, execute one or more methods, execute one or more models, the like, or any combination thereof. One or more computing devices may include or be in communication with one or more other computing devices, processors, storage mediums, databases, interaction devices, pet health devices, visual monitoring devices, or any combination thereof. One or more computing devices may communicate with one or more visual monitoring devices, pet health devices, computing devices, processors, storage mediums, databases, or any combination thereof through an interaction interface, dispatch interface, or both. Communication between computing devices may be controlled or managed via a managed cloud service. The one or more computing devices may include one or more non-transitory storage mediums. A non-transitory storage medium may include one or more physical servers, virtual servers, or a combination of both. One or more servers may include one or more local servers, remote servers, or both. One or more computing devices may include and/or use one or more processors of a visual monitoring device, pet health device, personal computers (e.g., laptop, desktop, etc.), mobile computing devices (e.g., tablet, mobile phone, etc.), servers, or a combination thereof. One or more computing devices may use (e.g., include) one or more processors.

The water dispenser, visual monitoring device, image processing unit, one or more computing devices, or other components of a visual monitoring system may include one or more processors. One or more processors may function to analyze data, execute instructions, transmit data, or any combination thereof. The one or more processors may be located within any component of the visual monitoring system. The one or more processors may include a single or a plurality of processors. The one or more processors may function to process data, execute one or more instructions to analyze data, or both. Processing data may include receiving, transforming, outputting, executing, the like, or any combination thereof. One or more processors may be in communication with one or more memory storage devices. One or more processors may access and execute one or more instructions stored within one or more storage mediums. Instructions may include software, algorithms, models, and/or the like. One or more processors may store processed data within one or more storage mediums. One or more processors may be part of one or more hardware, software, systems, or any combination thereof. The one or more processors may be referred to as one or more electronic processors. One or more hardware processors may include one or more central processing units, multi-core processors, front-end processors, graphics processors, the like, or any combination thereof. One or more processors may include one or more central processing units (CPU), graphics processing units (GPU), or both. One or more processors may be in communication with, work together with, or both one or more other processors. For example, a central processing unit may cooperate with a graphics processing unit. One or more processors may be a processor, microprocessor, electronic circuit, the like, or a combination thereof. For example, a central processing unit may be a processor or microprocessor. A central processing unit may function to execute instructions stored within a memory medium of the recognition device. An exemplary central processing unit may include the Cortex-A57 processor provided by Arm Limited, the processor and its specifications incorporated herein by reference for all purposes. As an example, a graphics processing unit may include one or more electronic circuits. A graphics processing unit may function to accelerate creation and rendering of image data. Image data may include images, videos, animation, frames, the like, or a combination thereof. The graphics processing unit may be beneficial in performing fast math calculations associated with the image data and freeing up processing capacity of the central processing unit. An exemplary graphics processing unit may include the GeForce® GTX 1650 D6 0C Low Profile 4G (model number GV-N 1656OC-4GL) by GIGA-BYTE Technology Co., the module and its specifications incorporated herein by reference. The one or more processors may be non-transitory. The one or more processors may convert incoming data to data entries to be saved within one or more storage mediums.

The water dispenser, visual monitoring device, image processing unit, one or more computing devices, or other components of a visual monitoring system may include one or more memory storage devices (e.g., electronic memory storage device, storage medium, memory storage medium). The one or more memory storage devices may function to store data, databases, instructions, or any combination thereof. The one or more memory storage devices may include one or more hard drives (e.g., hard drive memory), chips (e.g., Random Access Memory “RAM)”). discs, flash drives, memory cards, the like, or any combination thereof. One or more discs may include one or more floppy diskettes, hard disk drives, optical data storage media including CD ROMs, DVDs, and the like. One or more chips may include ROMs, flash RAM, EPROMs, hardwired or preprogrammed chips, nanotechnology memory, or the like. The data stored within one or more memory storage devices may be compressed. encrypted, or both. The one or more memory storage devices may be located within a recognition device. One or more memory storage devices may be non-transitory. One or more memory storage devices may include one or more memory mediums, storage mediums, the like, or a combination thereof. One or more memory mediums may store one or more computer executable instructions. One or more memory mediums may store one or more algorithms, methods, rules, the like, or any combination thereof. One or more memory mediums may be accessible by one or more processors (e.g., CPU, GPU) to read and/or execute one or more computer executable instructions. An exemplary memory medium may include the Kingston ValueRAM 4GB DDR SDRAM Memory Module, the memory module and its specifications incorporated herein by reference. One or more storage mediums may store one or more databases. One or more storage mediums may store one or more algorithms, methods, rules, the like, or a combination thereof. One or more storage mediums may store one or more computer executable instructions. Instructions, algorithms, methods, rules, and the like may be transferred from one or more storage mediums to one or more memory mediums for accessing and execution by one or more processors. One or more storage mediums may store one or more data entries in a native format, foreign format, or both. One or more storage mediums may store data entries as objects, files, blocks, or a combination thereof. One or more storage mediums may store data in the form of one or more databases. One or more storage mediums may store data received from one or more processors (e.g., CPU, GPU). One or more storage mediums may store data received from one or more processors after the one or more processors execute one or more instructions from one or more memory mediums. An exemplary storage medium may include the 16 GN eMMC Module XU4 Linux sold by HardKernel Co., Ltd., the module and its specifications incorporated herein by reference.

One or more storage mediums may include one or more databases. The one or more databases may function to receive, store, update, and/or allow for retrieval of one or more data entries, instructions, or both. The one or more databases may be located within one or more memory storage mediums. The one or more databases may include any type of database able to store digital information. The digital information may be stored within one or more databases in any suitable form using any suitable database management system (DBMS). Exemplary storage forms include relational databases (e.g., SQL database, row-oriented, column-oriented), non-relational databases (e.g., NoSQL database), correlation databases, ordered/unordered flat files, structured files, the like, or any combination thereof. The one or more databases may store one or more classifications of data models. The one or more classifications may include column (e.g., wide column), document, key-value (e.g., key-value cache, key-value store), object, graph, multi-model, or any combination thereof. One or more databases may be located within or be part of hardware, software, or both. One or more databases may be stored on a same or different hardware and/or software as one or more other databases. The databases may be located within one or more non-transient storage mediums. One or more databases may be located in a same or different non-transient storage medium as one or more other databases. The one or more databases may be accessible by one or more processors to retrieve data entries for analysis via one or more algorithms. The one or more databases may be one or more cloud-based databases. Cloud-based may mean that the one or more databases may reside in a non-transient storage medium located remote from the water dispenser. One or more cloud-based databases may be accessible via one or more networks. One or more databases may include one or more databases capable of storing one or more conditions of a water dispenser, one or more status signals related to water dispenser, one or more instruction signals sent to a water dispenser, one or more users, one or more user accounts, one or more registered water dispensers, one or more, the like, or any combination thereof. The one or more databases may include a Pet Profile Database, Water Consumption Database, Device Database, a User database, a User Computing Device database, a Registered Device database, a User Settings database, the like, or any combination thereof. Some of the databases may be combined with one another as opposed to separate. Some databases may be stored locally while others are remotely stored, all stored remotely, or all stored locally. One suitable database service may be Amazon DynamoDB®) offered through Amazon Web Services®, incorporated herein in its entirety by reference for all purposes. Some of the databases may be similar in structure to those disclosed in U.S. Pat. No. 11,399,502, incorporated herein by reference in its entirety for all purposes.

One or more databases may include one or more pet profile databases. One or more pet profile databases may function to store identification data, cooperate with one or more identifiers and/or identification sensors to identify an animal, cooperate with one or more visual monitoring devices to identify an animal, provide animal specific data to determine expected water consumption, the like, or any combination thereof. One or more pet profile databases may store data related to one or more specific animals including images, identifier data, species, breed, age, date of birth, gender, weight, language preference for commands, health issues, the like, or any combination thereof.

One or more databases may include one or more water consumption databases. One or more water consumption databases may function to store baseline factors for determining water consumption, calculated water consumption data from a visual monitoring system, or both. One or more water consumption databases may be accessible by one or more processors to also cooperate with data from one or more pet profile databases. One or more water consumption databases may store standard and/or updated factors, multipliers, calculations, etc. which are used to determine water consumption and/or expected water consumption. One or more water consumption databases may store recorded data from when an animal is consuming water. One or more water consumption databases may store the data collected from any of the methods disclosed herein.

The water dispenser, visual monitoring system, or both may include, or be in communication with, one or more applications. The application (i.e., “computer program”) may function to access data, upload data, receive data, or a combination thereof relative to the water dispenser and/or visual monitoring system; interact with a user interface; or any combination thereof. The application may be stored on one or more memory storage devices. The application may be stored on one or more personal computing devices. The application may comprise and/or access one or more computer-executable instructions, algorithms, rules, processes, methods, user interfaces, menus, databases, the like, or any combination thereof. The computer-executable instructions, when executed by a computing device, may cause the computing device to perform one or more methods described herein. The application may be downloaded, accessible without downloading, or both. The application may be downloadable onto one or more computing devices. The application may be downloadable from an application store (i.e., “app store”). An application store may include, but is not limited to, Apple® App Store®, Google Play®, Amazon®) Appstore, or any combination thereof. The application may be accessible without downloading onto one or more computing devices. The application may be accessible via one or more web browsers. The application may be accessible as a website. The application may interact and/or communicate through one or more user interfaces. The application may be utilized by one or more computing devices. The application may be utilized on one or more computing devices. The application may also be referred to as a dedicated application.

One or more computing devices (e.g., personal computing devices) may include one or more user interfaces. The one or more user interfaces may function to display information related to a water dispenser, visual monitoring system, and/or one or more animals (e.g., usage, consumption, trends, etc.); receive user inputs from a user (e.g., animal caregiver); display data and/or one or more prompts to a user; or any combination thereof. The one or more user interfaces may be suitable for receiving data from a user. The one or more user interfaces may include one or more graphic user interfaces (GUI), audio interfaces, image interfaces, the like, or any combination thereof. One or more graphic user interfaces may function to display visual data to a user, receive one or more inputs from the user, or both. The one or more graphic interfaces may include one or more screens. The one or more screens may be a screen located on a computing device. The one or more screens may be a screen on a mobile computing device, non-mobile computing device, or both. The one or more graphic interfaces may include and/or be in communication with one or more user input devices, audio interfaces, image interfaces, the like, or any combination thereof. The one or more user input devices may allow for receiving one or more inputs from a user. The one or more input devices may include one or more buttons, wheels, keyboards, switches, mice, joysticks, touchpads (i.e., a touch-sensitive area, provided as a separate peripheral or integrated into a computing device, that does not display visual output), touch-sensitive monitor screens, microphones, the like, or any combination thereof. The one or more input devices may be integrated with a graphic user interface. An audio interface may function to project sound to a user and/or receive sound from a user. The audio interface may include audio circuitry, one or more speakers, one or more microphones, the like, or any combination thereof. An image interface may function to capture, receive, display, and/or transmit one or more images. An image interface may include one or more cameras. A user interface may function to display and/or navigate through one or more menus of the application and cause one or more actions.

The general teachings of U.S. Pat. No. 11,399,502 for connecting one or more computing devices to a pet health device (e.g., litter box) may be applicable for connecting one or more computing devices to the water dispenser and visual monitoring device of the present teachings. In essence, a similar system architecture, network structure, computing device structure, and/or controllers may be incorporated into the present teachings. As such, U.S. Pat. No. 11,399,502 is incorporated herein by reference in its entirety for all purposes.

### Data Collection Method From Visual Monitoring System

The visual monitoring system may be useful in collecting data, storing data, or both related to one or more animals, their usage of the water dispenser, and/or one or more statuses of the water dispenser. The data collection method may be accessible by, stored within, and/or executed by a visual monitoring system, water dispenser, computing device(s) (e.g., personal computing device, user interface, cloud computing system, one or more servers, etc.), the like, or any combination thereof. The data collection method may relate specifically to visual data and related data which is associated with the visual data. The data collection method may be referred to as a visual data collection method.

The visual data collection method (e.g., algorithm) may be software stored in one or more components of the visual monitoring system. The visual data collection method may be stored fully and/or partially directly on a visual monitoring device, remote from a visual monitoring device, directly on a water dispenser, remote from a water dispenser, within cloud computing storage (e.g., a remote computing device, remote server), a personal computing device (e.g., mobile phone, tablet, application), the like, or any combination thereof. The data collection method may be executed by one or more processors, such as one or more processors of one or more computing devices. The data collection method may be executed by an image processing unit of a visual monitoring system, one or more processors of a water dispenser, one or more processors of a cloud computing system, one or more processors of a personal computing device, the like, or a combination thereof. The data collection method may be executed entirely locally to the visual monitoring device and/or water dispenser, rely on edge computing, rely on cloud computing, or any combination thereof.

The data collection method may be useful in identifying one or more animals via visual recognition, monitoring the usage of the water dispenser by one or more animals, determining one or more trends regarding usage of the water dispenser by one or more animals, identifying one or more deviations from one or more trends, detecting the presence of one or more health issues or other concerns based on deviation(s) of one or more trends, detecting a status of one or more pet health devices, the like, or any combination thereof. The data collection method may include one or more of the following steps: initiating a video stream, video acquisition, processing of the video, facial recognition, event determination, and/or the like.

The data collection method may include initiating a video stream. The data collection method may be automatically triggered by one or more visual monitoring device inputs, one or more sensing devices triggering execution, or both. the video stream may be initiated upon one or more animals coming into a line of sight of one or more visual monitoring devices (e.g., camera). Upon coming into the light of a sight, a video stream may be commenced. Sensing of an animal at a water dispenser may also initiate a video stream. For example, an identification sensor sensing an identifier within its sensing range. In the alternative, a video stream may be continuously running. The video stream may be transmitted from the visual monitoring device to one or more image processing units and/or other processors. If identification of the animal is known at the time of initiating a video stream, identifier data may be automatically paired to the video stream. For example, if a specific identifier being sensed by an identification sensor triggered initiating the video stream, then the data related to the identifier may be paired with the data of the videos stream.

The data collection method may include video acquisition. Video acquisition may collect a video stream received by one or more visual monitoring device inputs. Video acquisition may collect one or more images, videos, frames, sounds, the like, or any combination thereof. Video acquisition may be automatically executed by an imaging processing unit and/or other processors. Video acquisition may be automatically executed within the visual monitoring system or remote from the visual monitoring system. Video acquisition may include receiving the incoming video stream and storing the video stream. The video stream may be stored within a memory storage device part of or remote from the visual monitoring system. The video stream may be associated with one or more identifiers prior to storage. One or more processors may associate the video stream (or portions thereof with one or more identifiers) before saving in storage. One or more identifiers may include an identity of one or more animals, a camera associated within the video stream, one or more water dispensers associated with the video stream, a timestamp, a duration, a geolocation, the like, or any combination thereof.

The data collection method may include processing. Processing may function to break down an incoming video stream into a format which can be further analyzed, stored, or both. Processing may access the video stream from storage, prior to being stored, or both. Processing may be executed by one or more processors. The one or more processors may be part of or remote from the visual monitoring system. The video stream may be broken down into frames. The one or more frames may then be stored into one or more storage mediums, have one or more identifiers associated therewith, or both. For example, the one or more frames may be stored into one or more consumption databases for storage and/or analysis.

The data collection method may include event determination. Event determination may use one or more outputs from a video stream, processing, and/or the like. Event determination may evaluate one or more frames derived from a video stream. Event determination may be the determination of one or more activities occurring by one or more animals, at one or more water dispensers, or the like. Event determination may include determining an animal is consuming liquid (e.g., water) from a water dispenser, approaching a water dispenser, leaving a water dispenser, playing (e.g., splashing) with the water, sniffing the water, the like, or any combination thereof. An event determination may be associated with a time duration, such as by associating the timestamps of frames of the determined activity. Event determination may be completed by an event determination model. The event determination model may be a machine learning or artificial intelligence model. The event determination may be a trained model. The training may be via a supervised model, an unsupervised model, or both. The event determination model may identify various events of an animal interacting with a water dispenser (e.g., approaching, consuming, departing, playing, sniffing). The event determination model may be continuously validated and trained after each execution.

### Method of Visually Monitoring Liquid Consumption From a Dispenser

The one or more visual monitoring systems of the present teachings may be particularly beneficial in determining an amount of liquid consumed by an animal, consumption of liquid from a water dispenser, an amount of liquid remaining in a dispenser, or any combination thereof.

The method disclosed herein may incorporate and be useful with the water dispenser and/or data collection of the present teachings.

The present disclosure may relate to a method for monitoring and determining consumption from a water dispenser by an animal. The method may include any one of: a) an animal approaching the water dispenser and coming into a view of a visual monitoring device; b) the animal consuming (e.g., lap, swallow) a liquid from a serving area of the water dispenser; c) the visual monitoring device receiving an incoming video data of the animal consuming the liquid; d) automatically determining an amount of the liquid consumed by the animal based on the incoming video data.

The method may include an animal approaching the water dispenser and coming into a view of a visual monitoring device. For the method to be initiated, an animal must first approach a water dispenser. Upon approaching a water dispenser, the animal may be detected by one or more sensing devices of the water dispenser, the visual monitoring system, or both. A visual monitoring device may be continuously and/or intermittently running. For continuous running visual monitoring devices, an animal may be detected by coming into a line of sight of the visual monitoring device. For intermittent or even continuous running visual monitoring devices, detection of the animal by one or more other sensing devices, separate from the visual monitoring device, may activate a video monitoring device to commence receiving incoming data (e.g., start recording). The one or more sensing devices may detect motion and/or the presence of the animal.

The method may include executing a data collection method. The data collection method may be the data collection method as taught herein. A data collection method may be initiated upon activation of the one or more visual monitoring devices, detection of an animal, the animal coming into view of a visual monitoring device, or any combination thereof.

The method may include one or more visual monitoring devices receiving a video stream. The video stream may be of the animal in proximity of the water dispenser, approaching the serving bowl, at the serving bowl, directly in front of the water dispenser, within a sensing range of the water dispenser, within a same setting (e.g., room) as the water dispenser, the like, or any combination thereof. The visual monitoring device may begin and/or continue recording and generating video data. For example, if the visual monitoring device operates intermittently and is activated by an animal approaching, the visual monitoring device may commence recording and generating video data. For example, if the visual monitoring device operates substantially continuously, the visual monitoring device may continue recording and generating video data. Recording and generating may be as described within the data collection method. The video data may be transmitted to one or more computing devices. The video data when being recorded and generated may be referred to as incoming video data. Receiving a video stream may be part of initiating a video stream and/or video acquisition of a data collection method.

The method may include automatically identifying an animal within a line of sight of the visual monitoring device. An identification of the animal may be generated by one or more computing devices, one or more visual monitoring devices, one or more sensing devices, any components of the water dispenser and/or visual monitoring system, the like, or any combination thereof. One or more components may cooperate with one or more other components to identify the animal. Identification may include a species of animal (e.g., dog, cat), a breed of an animal, a size of an animal, a gender of an animal, an age of an animal, the like, or a combination thereof. Identification may even include the exact identification of the animal. Identification, even exact identification, of the animal may be executed via visual recognition, one or more identifications sensors communicating with one or more identifiers, the like, or any combination thereof.

Automatically identifying an animal may include one or more identification sensors receiving identifying data from one or more identifiers. One or more identifiers entering a sensing range of one or more identification sensors may establish a connection with the identification sensor and/or be read by the identification sensor. Identity of the animal, or related identifying data (e.g., a serial number or another number that corresponds to an identity in a database), may be received by the identification sensor. For example, one or more identification sensors may receive identifying data from an identifier. The identifying data may be received wirelessly. The one or more identification sensors may transmit the identifying data (e.g., convert to a signal) to one or more processors. The one or more processors may be local (e.g., part of) and/or remote from the water dispenser and/or visual monitoring device. One or more processors may search and/or retrieve from one or more databases (e.g., identification database, pet profile database) for identification of the animal matching the identifying data.

Automatically identifying an animal may include identifying an animal via visual recognition. An animal entering into the range of the visual monitoring device may have their identification recognized once in the line of sight. Video acquisition as disclosed in the data collection method herein may provide for the images analyzed for visual recognition. One or more computing devices may utilize recognition software to compute the visual image(s) of the animal with one or more pet profiles to determine an exact identification of the animal. Recognition software may include processes such as face extraction, overall body extraction, face detection, pose detection, facial analysis, the like, or any combination thereof. Exemplary software suitable for facial recognition may include DeepFace, CompreFace, Face Recognition, InsightFace, FaceNet, InsightFace-REST, the like, or any combination thereof, which are incorporated herein by reference in their entirety. The software may be trained to identify specific animals over humans. Exemplary training models may include YOLOv5 (You Only Look Once), incorporated herein by reference in its entirety. Identification may make use of one or more machine learning models (e.g., DNN and CNN models). Identification may take place as disclosed in U.S. Provisional Patent Application Nos. 63/490,990 and 63/490,910, both filed on Mar. 17, 2023, which are incorporated herein by reference in their entirety for all purposes.

The method may include an animal consuming water. Consumption may be notable by one or more motions of or near the mouth and/or neck of the animal. Consumption may be notable by a tongue lapping at the water, a mouth opening and closing, a swallowing reflex in the throat, the like, or a combination thereof. Determining water consumption may occur as part of an event determination step in a data collection method.

Consuming may include an animal using their tongue to consume water. Most animals consume water by lapping the water. Some animals, like dogs, form a scoop shape with their tongue in which water is gathered and then transferred into their mouth for swallowing. Other animals, like cats, drink water by inertia overcoming gravity. In other words, the tongue (i.e., tip of tongue) collects water on its surface which is then transferred to the mouth for swallowing before gravity takes over and causes the water to fall off the tongue. Each lap of the tongue of an animal may be associated with a generally consistent volume of water. An animal may lap a certain number of times while at a water dispenser. The lapping may be at a steady pace, irregular pace, or both. Knowing the volume of liquid consumed with each lap and a number of laps per visit may allow for a total volume of liquid consumed at each visit, or over a period of time, to be determined.

The method may include the visual monitoring device receiving incoming video data of the animal consuming the liquid. Incoming video data may be received such as described hereinbefore, including, with respect to, the data collection method. Incoming video data may include recorded video data of a face of the animal, a mouth of the animal, a neck of the animal, a tongue of the animal, the liquid consumed by the animal, the serving bowl from which the animal is consuming, one or more measurement aids captured in view of the camera, identifying data of the animal, the like, or any combination thereof. The incoming video data may be paired with the identity data of the animal such that it is understood the incoming video data is associated with a specific animal. As an alternative or in combination, the incoming video data may be used to determine the identity of the animal. The incoming video data may be first received by one or more image sensors. The incoming video data may then be transmitted to one or more processors. The incoming video data may be relayed to one or more other processors. The incoming video data may remain local at the water dispenser and/or visual monitoring system, be transferred remotely, or both. The incoming video data may undergo processing, storage, and even event determination as described with respect to the data collection method.

The method may include automatically determining and/or estimating an amount of the liquid consumed by the animal based on the incoming video data. The incoming video data may be analyzed to determine the amount of liquid. The incoming video data may be analyzed to identify the animal, a number of laps by the animal during a visit and/or period of time, determine an amount of liquid remaining via a measurement aid, or any combination thereof. Identification may occur as disclosed hereinbefore.

The incoming video data may be analyzed by one or more processors to determine a number of occurrences of laps and/or other swallowing actions over a period of time. This may be referred to as executing a total lap model. The number of laps and/or other swallowing actions over a period of time may be used to determine (or estimate) the volume of liquid consumed. Determination may be conducted via a swallow detection model. The swallow detection model may be a machine learning or artificial intelligence model. The swallow detection model may be a trained model. The training may be via a supervised model, an unsupervised model, or both. The swallow detection model may identify what a lap and/or other swallowing action visually appears and/or sounds like, count the number of occurrences during a visit to the water dispenser, time the span of the visit to the water dispenser, and/or the like. The swallow detection model may identify what a lap and/or other swallowing action appears like at the tongue, mouth, and/or even throat of an animal. The swallow detection model may be continuously validated and trained after each execution. The swallow detection model may identify an occurrence and period output in an incoming video data stream as a number of laps and/or other swallowing actions and the period of time the laps and/or swallowing actions occurred in. The swallow detection model may pair the occurrence and period output with the identifying data and/or the identification of the animal.

The incoming video data may be analyzed to determine and/or estimate the volume of liquid consumed. The incoming video data stream may be analyzed by one or more processors to determine the volume. The incoming video data stream may be analyzed by a volume detection model. A volume detection model may be used as the initial data input for the occurrence and period output from the swallow detection model. The occurrence and period output may be used as opposed to the entirety of the incoming video data. The volume may be determined and/or estimated by comparing the identity of the animal with one or more identities stored in one or more pet profile databases, consumption reference databases, or both. For example, the identity of the animal may be retrieved or may have already been retrieved from a pet profile database. One or more identification traits of the animal may be compared to one or more identification traits in a consumption reference database. For example, the consumption reference database(s) may store typical volumes associated with laps and/or swallows based on animal species, breed, size, gender, age, and/or the like. For example, an average sized (i.e., 8 lbs-11 lbs) domesticated cat may be associated with a volume of 0.1 mL of liquid per lap. The volume may be determined and/or estimated by analyzing the size of the water collected on the tongue of the animal and recorded on the video stream. The total volume consumed for a period of time may then be determined by the volume detection model by multiplying the number of laps identified over the period with the volume associated with the identity and/or identification traits of the animal.

In addition to, or as another alternative, the amount of liquid consumed may be determined and/or estimated with the aid of one or more mass sensors. A volume of liquid within the water dispenser overall, a serving bowl, one or more tanks, a reservoir, the like, or a combination thereof may be associated with one or more weights (can also be referred to as mass). As the weight is reduced due to consumption by an animal, that weight may be associated with a volume. The weight or associated volume may be compared with one or more prior weights and or associated volumes to determine the amount consumed by an animal. Measurement by one or more mass sensors may be used to verify, calibrate, and/or recalibrate the accuracy of, or even correlate to, the measurement via video stream and the volume detection model, or even used in lieu of the volume detection model. It is possible that mass sensors and other sensing devices, on their own, may not be able to quickly detect a mass or volume change from the small amounts of liquid consumed at a single visit but may be advantageous in sensing a change over a longer period of time.

One or more mass sensors (or other sensing devices) may be used to more accurately determine and/or estimate an amount of liquid consumed, cooperate with video data, aid in determining a volume per lap and/or swallow, or any combination thereof. It is possible that measuring consumption from one or more animals solely via video may not provide sufficient data to accurately measure the volume consumed. For example, an animal may consume too small of a volume of liquid to accurately be quantified solely via video stream. Over a period of time, the mass of the water dispenser and volume of fresh liquid will decrease due to consumption by an animal. The period of time may be between refills of a fresh liquid tank, over a predetermined time period. or both. A predetermined time period may be 12 hours, 24 hours, 36 hours, 48 hours, or even 72 hours or more. This decrease during the period of time can be referred to as a volume reduction, mass reduction, or other measurement reduction (e.g., change in height of water level within a fresh liquid tank). By measuring the reduction over a period of time, potential pitfalls of using mass sensors, or similar, may be avoided. For example, they may be able to accurately determine changes over longer time periods (e.g., 24 hours) as compared to single visits by an animal. The reduction may be converted to a volume reduction. In other words, a change in mass may be converted to a change in volume. The volume reduction during the predetermined time period may then be correlated with the number of laps during the same predetermined time period. This correlation may result in determining a fixed constant value. The fixed constant value may be calculated by dividing the volume reduction during the predetermined time period by the number of laps during the same predetermined time period. The fixed constant value may be provided as a volume per lap. The fixed constant value may then cooperate with each lapping instance detected by video monitoring to determine an amount (e.g., volume) of liquid consumed by an animal. More specifically, the number of laps per visit (or even over a time period) at the water dispenser detected by visual monitoring may be multiplied by the fixed constant value to determine a volume of liquid consumed during that visit (or during the time period). The fixed constant value may be updated every new predetermined time period or even over an extended time period. For example, the fixed constant value may be updated every 24 hours, every week, or even every month. An initial reference fixed constant value may be provided in a database before the video monitoring and/or sensing devices are in use. This application of a fixed constant value may be referred to as executing a calibration model.

In case of multiple animals using the same water dispenser, a common fixed constant value may be applied to the multiple pets while the video monitoring may use pet recognition and apply the fixed constant value to the individual pet's drinking instances. This may aid in capturing the consumption trends of individual animals. A more accurate fixed constant value may be determined for an individual animal by isolating that animal with the water dispenser during the predetermined time period and setting the resulting fixed constant value for that specific animal.

In addition to, or as an alternative, the amount of liquid consumed may be determined and/or estimated by verifying how much liquid is remaining in a serving bowl and comparing it to a previous measurement. For example, the incoming video data may capture one or more measurement aids in a serving bowl and the presence of liquid (or food) in a serving bowl. One or more processors may then associate the amount of liquid or food to the one or more measurement aids and then associate that to a volume. This data may be used for determining an amount consumed, verifying an amount consumed (e.g., comparing with the volume determination from lapping), or the like.

The method may include determining the amount of fresh liquid available in a water dispenser. This may be referred to as a volume remaining model. The method may include subtracting the amount of determined liquid consumed by an animal from a known amount (e.g., freshly filled) of liquid in a tank of a dispenser. The method may include determining the current amount (e.g., volume) of liquid in a tank of a dispenser. The current amount may be determined by subtracting the determined liquid consumed by an animal by a last determined current amount of liquid in a tank of a dispenser. After a user fills a tank to a certain level (e.g., maximum level), the current amount may be the volume of liquid at that fill level. The user may input into a computing device, onto the water dispenser, or both when they have filled/refilled a tank. The water dispenser may have one or more sensing devices on board which determine when a user has filled a tank.

In addition to, or as another alternative, the amount of fresh liquid available in a water dispenser may be determined by the use of one or more mass sensors. Similar to determining the volume consumed, a weight may be associated with a specific volume of water in the water dispenser overall, the fresh tank, the used tank, the reservoir, the serving bowl, and/or the like. It is possible that one or more mass sensors are isolated such that they only detect the mass of liquid within the fresh tank as opposed to liquid stored elsewhere within the water dispenser.

The method may include determining an estimate of when fresh liquid of a dispenser may be depleted, a tank needs to be refilled, or both. This may be referred to as a refill estimate model. The method may include estimating the amount of liquid remaining in a fresh tank (e.g., subtracting the amount consumed from the current amount). The method may include estimating the amount of liquid an animal consumes during each visit to the dispenser. The method may include estimating the frequency of an animal consuming liquid from the dispenser. The method may include determining one or more trends of the animal related to consumption (e.g., frequency, amount, duration, etc.). The method may include determining based on the one or more trends, how many more visits, time, or the like, may remain until the tank is empty and needs to be refilled. The estimate may be transmitted to one or more computing devices to notify one or more users.

The method may include identifying one or more consumption trends by one or more animals. This may be referred to as a consumption trend model. The method may include determining for an animal one or more trends related to an average amount consumed, average duration of consumption, average schedule and/or frequency of consuming, and/or the like. Based on one or more consumption trends, the method may include automatically determining the occurrence of a deviation from one or more trends, notifying a user of the deviation, or both. For example, identifying a user via a user interface of an animal drinking less and/or more volume than usual, drinking less and/or more frequently than usual, drinking for less and/or more time than usual, the like, or any combination thereof. Trends may be over a period of a week, month, three months, year, or even 3 years. Trends may be a moving trend over the period. Trends may be based on means, median, mode, range, the like, or any combination thereof.

The method may include notifying a user. This may be referred to as a notification model. Notifying a user may provide passive and/or active notifications via a user interface of a computing device. A passive notification may include a user opening an application, finding the data they are looking for (e.g., consumption history, consumption trends), or both. An active notification may include an application generating a notification on a display of the user interface, an application gaining the attention of a user, generating a pop-up and/or one or more sounds on a computing device, or any combination thereof. The notifications can include data such as total water intake over various periods (e.g., daily, weekly, monthly, etc.), average water intake over various periods (e.g., daily, weekly, monthly, etc.), water history of total water intake per visit or over any other time period, and/or the like. The notifications can alert a user as to a deviation from any consumption trends. For example, drinking more or less of a volume of water over a time period, drinking more or less frequently over a period of time, and/or the like.

The methods disclosed herein may include any step not requiring execution by the animal (e.g., approaching water dispenser, consuming water) or user (e.g., refilling fresh tank, emptying used tank) being automatically executed. Automatic execution may be achieved via one or more processors. One or more processors may automatically execute one or more software methods, algorithms, models, and/or the like. The results of one part of a method or the results of the method in its entirety may lead to an automatic execution of a subsequent step or method. Any of the processor's part of the system may drive the execution of any step of the process. For example, local processors (e.g., part of the visual monitoring device, water dispenser), remote processors (e.g., remote server, cloud computing), or even a combination thereof (e.g., edge computing).

The methods disclosed herein may include the use of machine learning and/or other artificial intelligence to complete one or more steps, to learn consumption trends of one or more animals, to provide a real-time liquid or food consumption status, the like, or any combination thereof. The inclusion of machine learning and/or other artificial intelligence may be referred to as an AI-powered method.

The AI-powered method may include behavior recognition. Behavior recognition may function to learn data and trends about individual animals and their use of a water dispenser, customize data related to an individual animal and/or user, provide a baseline of data regarding an individual animal, correct inaccurate detections by one or more other sensors, or any combination thereof. Behavior recognition may allow for the determination of consumption amount and/or rate; species, breed, gender, age, type, or other identifying information of an individual animal; progression in age, weight, and/or the like of an individual animal; the like; or any combination thereof. For example, behavior recognition may recognize an animal is aging by gaining or losing weight, changing in size, or the like. For example, behavior recognition may recognize an animal is consuming more or less liquid. AI may function to validate one or more readings from one or more other sensors, adjust the values received by one or more other sensors, or both. For example, through AI, laps detected by one or more image sensors may be correlated to a volume of liquid consumed by an animal. AI may cooperate with one or more sensors to more accurately estimate consumption by individual animals, learn consumption by an animal, more accurately estimate an amount of liquid within the dispenser (such as in a specific tank), provide recommendations to a user via a user interface, the like, or any combination thereof.

### Illustrative Examples

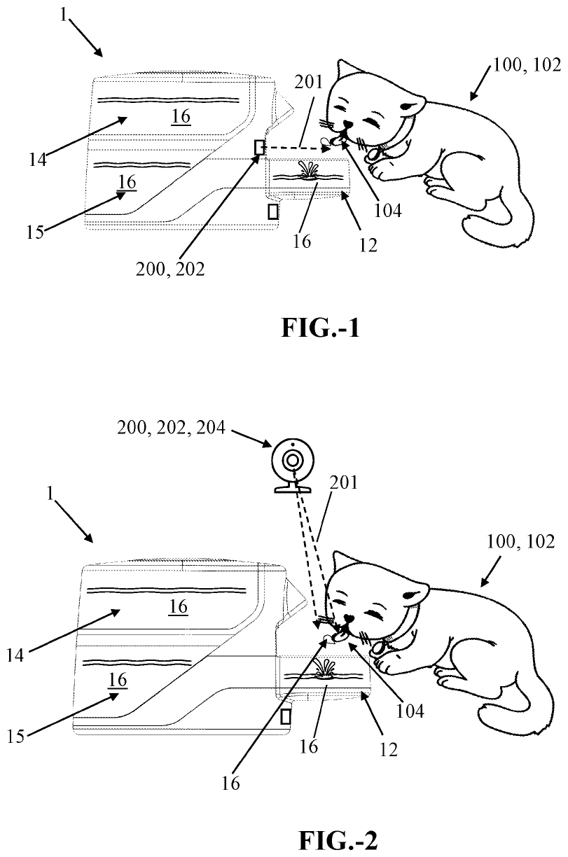

FIGS. 1 and 2 illustrate a water dispenser 1. The water dispenser 1 includes a serving bowl 12. The water dispenser 1 includes a fresh water tank 14. The water dispenser 1 includes a used water tank 15. An animal 100, such as a pet 102, consumes water 16 from the serving bowl 12. The animal 100 consumes water 16 with their tongue 104. Some animals, 100, such as a dog, may use their tongue 104 to scoop the water 16 into their mouth. Other animals, 100, such as a cat, may use their tongue 104 to pull water into their mouth before gravity pulls the water 16 away from their mouth. In other words, inertia keeps the water 16 moving upward toward their mouth. In either scenario, the tongue 104 of the animal 100 visibly laps water 16 from the serving bowl 12 for consumption.

FIG. 1 illustrates the water dispenser 1 including a visual monitoring system 200 integrated therewith. The visual monitoring system 200 includes a visual monitoring device 202. The visual monitoring device 202 is mounted on a front of the water dispenser 1 such as to have a line of sight 201 onto the animal 100. More specifically, a line of sight 201 to the mouth, specifically the tongue 104, of the animal 100.

FIG. 2 illustrates a visual monitoring system 200 separate from the water dispenser 1. The monitoring system 200 includes a visual monitoring device 202. The visual monitoring device 202 may be a video camera 204. The visual monitoring device 202 may have a line of sight 201 on a water dispenser 1, a serving bowl 12 of the water dispenser 1, and/or an animal 100 approaching and/or consuming from the water dispenser 1.

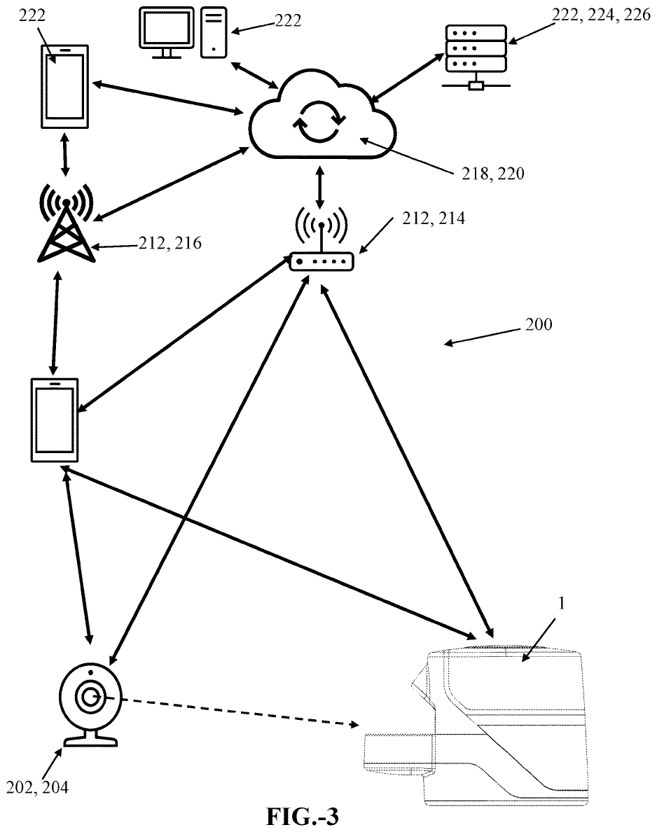

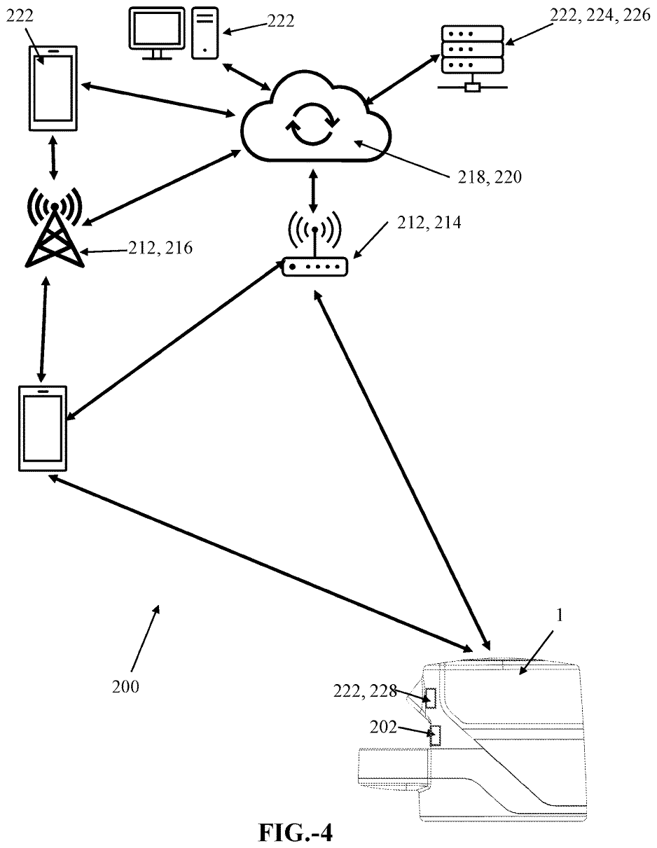

FIGS. 3 and 4 illustrate one or more visual monitoring systems 200. FIG. 3 illustrates a system 200 in which the visual monitoring device 202 with the video camera 204 is separate from the water dispenser 1 while FIG. 4 illustrates a system 200 in which the visual detection device 202 is part of the water dispenser 1. The visual monitoring device 202 and/or water dispenser 1 may be in communication with one or more communication hubs 212. The communication hubs 212 may include a router 214 and/or an antenna tower 216. The system 200 may incorporate and/or form a network 218. The network 218 may be the Internet 220, may refer to the connectivity of the components via one or more communication hubs 212, or both. Via the network 218, the visual monitoring device 202 may be in communication with one or more computing devices 222. The video monitoring device 202 and/or water dispenser 1 may be in communication with a computing device 222 either directly and/or indirectly, such as via a communication hub 212 and the Internet 220. Direct communication components can be via suitable wireless or wired method. Via the network 218, the water dispenser 1 and/or visual monitoring device 202 may be in communication with one or more remote computing devices 224. One or more remote computing devices 224 may include one or more servers 226, including processors and storage mediums. The one or more remote computing devices 224 may be useful for performing cloud computing, remote storage of data, and/or the like. The water dispenser 1 and/or visual monitoring device 222 may also include one or more computing devices 222 therein. This computing device 222 may allow for onboard processing, edge processing, cooperating with cloud/remote processing, and/or the like. The computing device 222 may be part of a controller 228. The controller 228 may include one or more processors, storage mediums, communication modules, and/or the like.

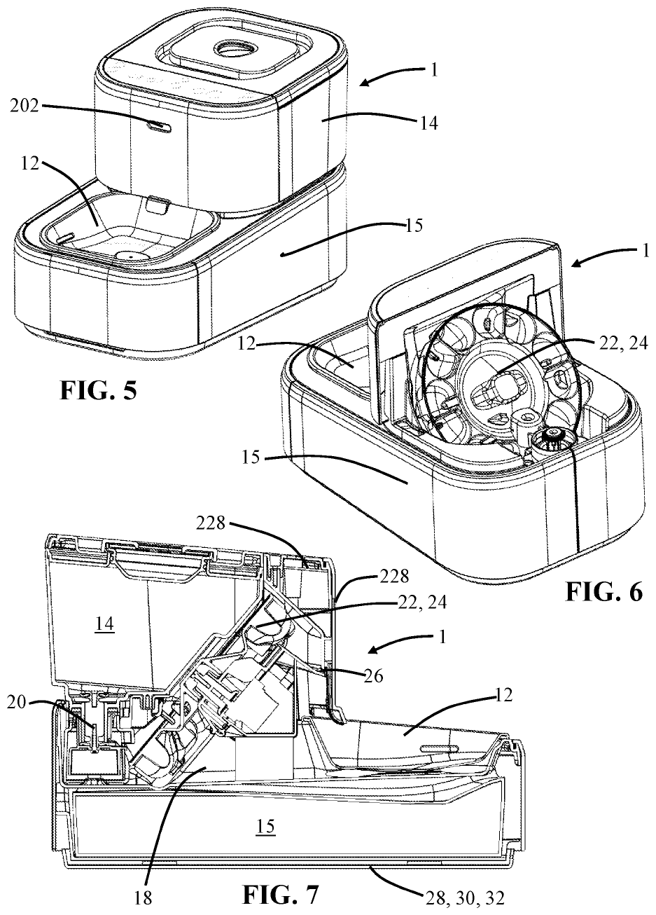

FIGS. 5-7 illustrate varying views of a water dispenser 1. The water dispenser 1 includes a serving bowl 12. The water dispenser 1 includes a fresh water tank 14 and a used water tank 15. Inside of the water dispenser 1 is a reservoir 18. The fresh water tank 14 releases fresh water into the reservoir 18 via a valve assembly 20. The water from the reservoir 18 is transported to the serving bowl 12 via an actuation means 22. An example actuation means 22 is a carousel 24. The carousel 24 moves the water toward a spout 26. The water is then able to exit via the spout 26 into the serving bowl 12. The carousel 24 may also work to recirculate water in the reservoir, collect water for disposing into the used water tank 15, or both. A visual monitoring device 202 is located toward the front of the water dispenser 1. The water dispenser 1 houses a controller 228. The controller 228 may be in the form of a printed circuit board (“PCB”). The visual monitoring device 202 may be in electrical communication with the controller 228. The water dispenser 1 also includes one or more other sensing devices 28. The sensing device 28 is illustrated as one or more mass sensors 30. The mass sensors 30 are shown as a scale 32 as the base of the dispenser 1.

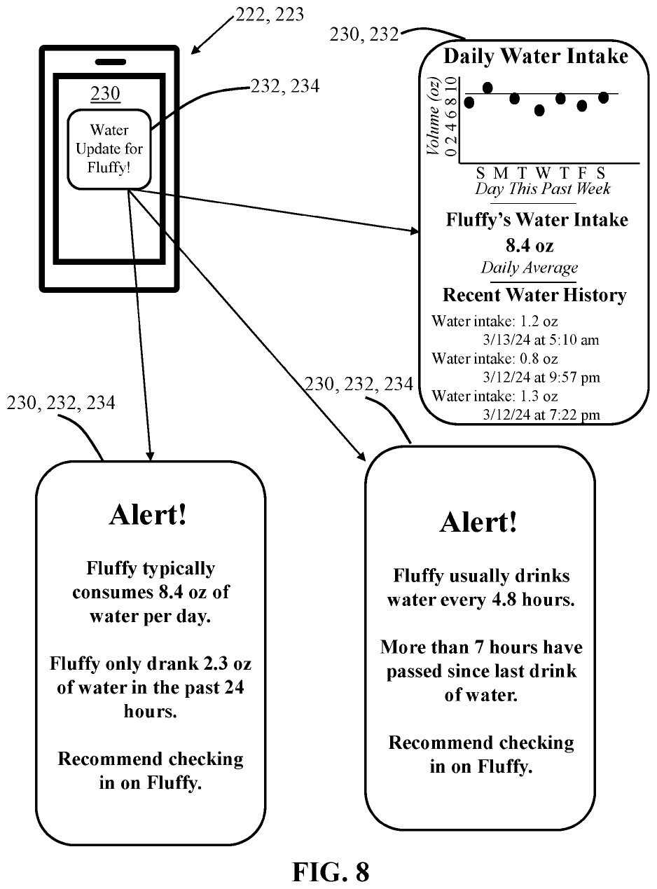

FIG. 8 illustrates varying views of an application 232 views on a user interface 230 of a computing device 222. The computing device 222 may be a mobile computing device 223 (e.g., mobile phone, tablet). The computing device 222 may have an application 232 running thereon. The application 232 may create and display a notification 234 on the user interface 230. The application 232 may be able to display and notify a user of various data related to an animal's water intake via the user interface 230. For example, trends regarding consumption of water may be displayed. Trends may include a daily total, daily average, average per visit (not shown), weekly average, etc. A history of water intake per detected visit may be displayed. Further, one or more notifications 234 may be displayed if an animal's consumption of water deviates from one or more trends. For example, a daily water intake being below or above a typical trend for the animal, a timespan since last consuming water being below or above a typical trend for the animal, etc. It can be understood that the consumption data illustrated on the user interface 230 may be stored within one or more consumption databases, pet profile databases, or both.

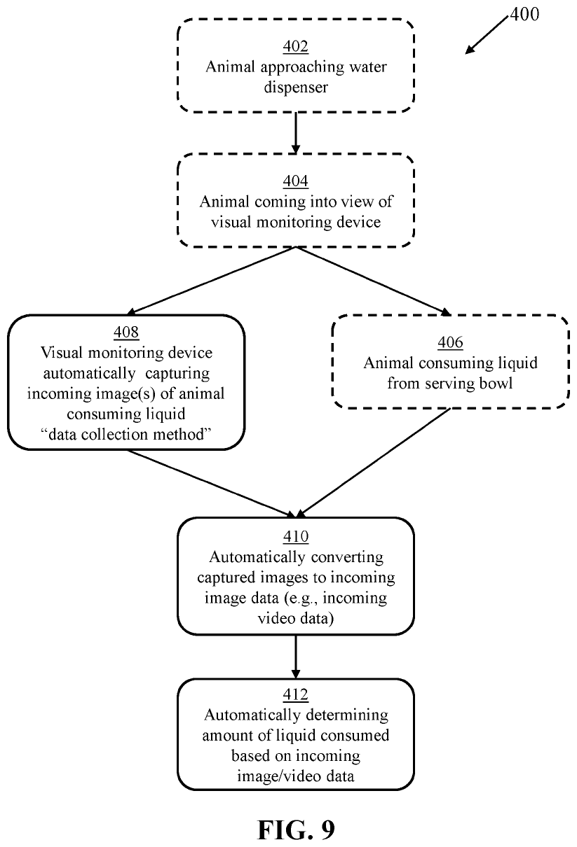

FIG. 9 illustrates a flowchart of a method 400 for monitoring and determining consumption from a water dispenser by an animal. The method includes an animal approaching the water dispenser 402 and then coming into a view of a visual monitoring device 404. Once at the water dispenser, the animal consuming (e.g., lap, swallow) a liquid from a serving area of the water dispenser 406. Either when the animal comes into view of the visual monitoring device, or even before, the method includes the visual monitoring device capturing incoming image(s) (e.g., incoming video stream, incoming video) of the animal consuming the liquid 408. Either while still receiving the video stream or after, while the animal is still consuming the liquid or when done, the method includes converting the incoming image(s) to incoming image data (e.g., incoming video data) 410. The incoming image data (e.g., incoming video data) may include: i) at least a portion of a face and/or neck (e.g., mouth, tongue, cheek, neck) of the animal visually indicating the animal is consuming the liquid; the surface area of the liquid in serving area; an inner surface of the serving area; and/or a plurality of measurement aids in the serving area. Based on the incoming video data, the method then includes automatically determining an amount of the liquid consumed by the animal based on the incoming image data 412. Boxes in the flowchart shown in dashed lines are steps completed by an animal and not automated. Boxes shown in solid lines are steps completed by the water dispenser and/or visual monitoring system which may be automatically executed.

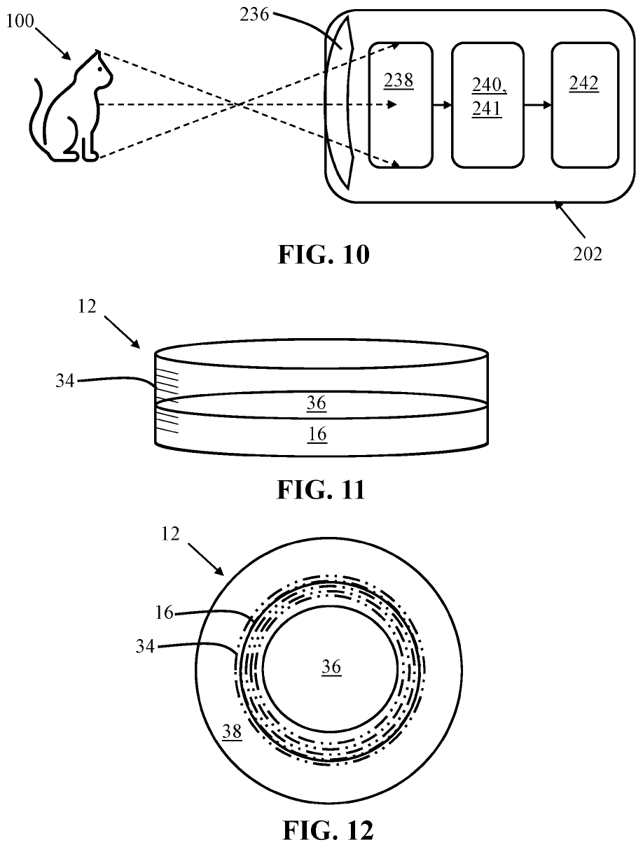

FIG. 10 illustrates an exemplary architecture of a visual monitoring device 202. The visual monitoring device 202 is able to capture an object, such as an animal 100, as an incoming video stream. The incoming images come in via a lens 236. The incoming video stream passes the lens 236 and is captured on an image sensor 238. The image sensor 238 is in communication with a processor 240, such as an image processor 241, and a storage medium 242.

FIGS. 11 and 12 illustrate a serving bowl 12 with water 16 therein. FIG. 12 illustrates a tapered serving bowl 12. The serving bowl 16 is shown having a measurement aid 34. The measurement aid 34 includes a plurality of marks. The marks may be along an interior surface 38 of the serving bowl 12. A visual monitoring device 204 (not shown) may have a view on surface area 36 of the water 16 and/or an interior surface 38 of the serving bowl 12.

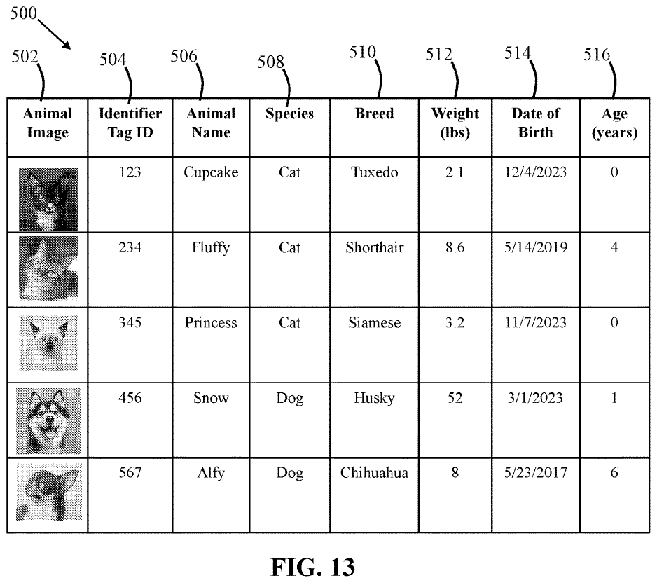

FIG. 13 illustrates a pet profile database 500. A pet profile database 500 may be a local database and/or global database. A local database may be a database for animals specific to a location or subset of locations (e.g., pets in a home or shelter). A global database may be a database of all or a variety of animals available stored on a remote computing device. The pet profile database 500 may include a plurality of data entries associated with each animal stored therein and related to an identity of the animal. The data entries per animal may include one or more images of the animal 502, one or more identifiers or data associated with an identifier 504, respective given names of the animal 506, species of the animal 508, breed of the animal 510, weight of the animal 512, date of birth of the animal 514, and age of the animal 516. It's also possible the database includes gender, area of residence (e.g., city, state, country), preferred language for a user (e.g., for reading/speaking) and/or animal (e.g., for commands), and the like.

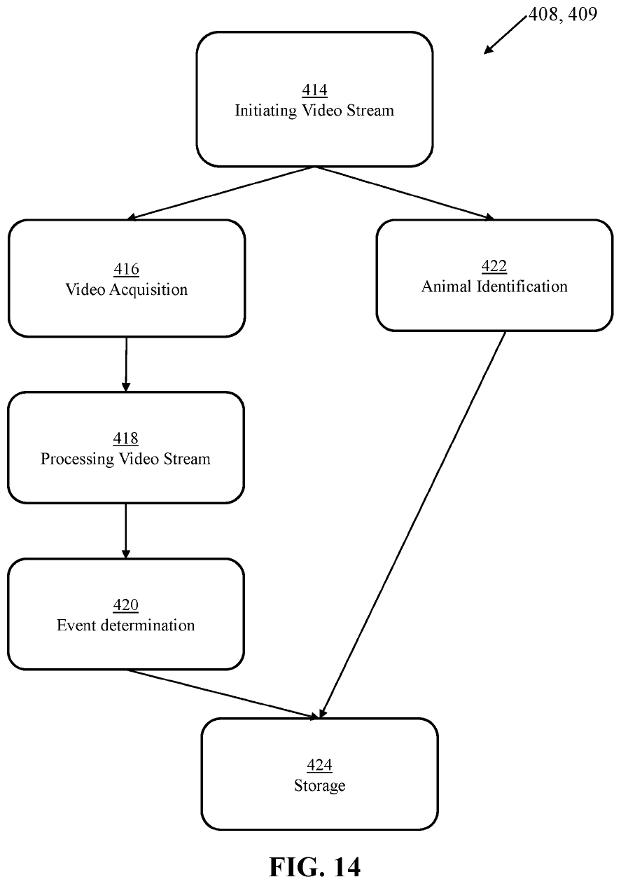

FIG. 14 is a flowchart of a data collection method 408. The data collection method 408 may be a visual data collection method 409. The method may include initiating a video stream 414. After initiating the video stream, video may be acquired 416. Once video is acquired 416, the method may include processing the video stream 418. After processing, the method may include event determination 420. Identification of the animal 422 may occur at any time based on the type of identification data being used (e.g., identifier, video recognition, etc.). The identification data of the animal 422 may be paired with any of the data collected from the video stream for storage 424 in one or more storage mediums.

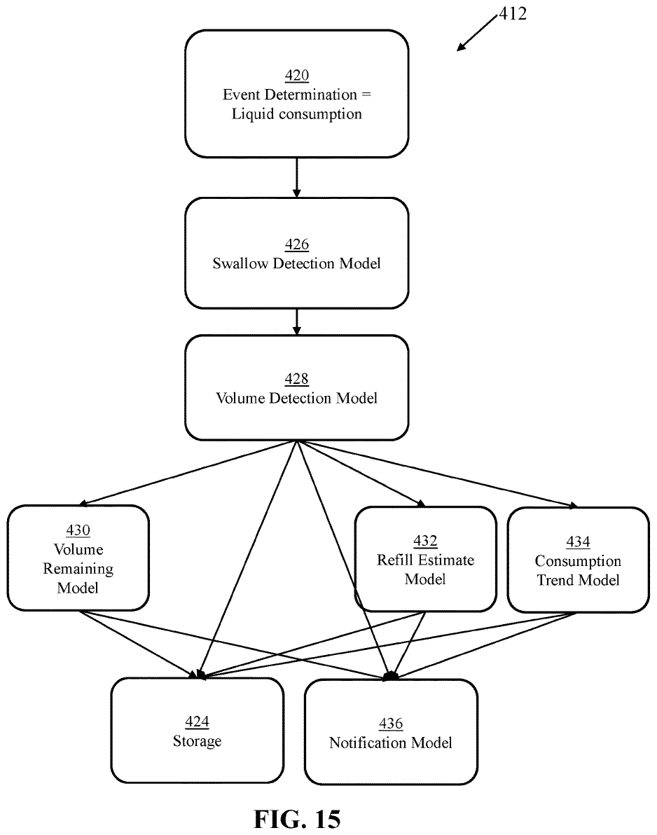

FIG. 15 illustrates a flowchart for determining liquid consumption 412. The process begins with the event determination 420 finding an animal is consuming liquid. Thereafter, a swallow detection model 426 is executed. After, a volume detection model 428 is executed. After the volume detection model 428, a notification model 436 can be directly executed. Additionally, or as an alternative, after the volume detection model 426, a volume remaining model 430, refill estimate model 432, and/or a consumption trend model 434 may all be executed. These subsequent models 430, 432, and 434 may also cause execution of a notification model 436. The notification model 436 may result in any of the user interfaces exemplified in FIG. 8 or similar. Results and/or calculations used in any of the models may be stored in one or more storage mediums 424.

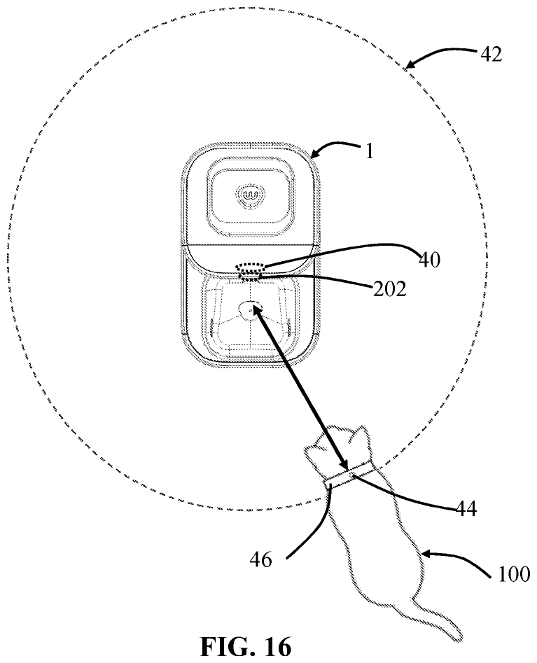

FIG. 16 illustrates a water dispenser 1. The water dispenser 1 includes a visual monitoring device 202. The water dispenser also includes an identification sensor 40. The identification sensor 40 has a sensing range 42. As an animal 100 approaches and enters into the sensing range 42, the identification sensor 40 is able to establish communication with an identifier 44. The identifier 44 may be part of or affixed to a collar 46. Any of the methods disclosed herein may be executed upon an animal 100 being detected within the sensing range 42.

### REFERENCE NUMBER LISTING

1—Water dispenser; 12—Serving bowl; 14—Fresh water tank; 15—Used water tank; 16—Water; 18—Reservoir; 20—Valve assembly; 22—Actuation means; 24—Carousel; 26—Spout; 28—Sensing device; 30—Mass sensor; 32—Scale; 34—Measurement aid; 36—Surface area/upper surface of water; 38—Interior surface of serving bowl; 40—Identification sensor; 42—Sensing range; 44—Identifier; 46—Collar; 100—Animal; 102—Pet; 104—Tongue; 200—Monitoring system; 202—Visual monitoring device; 204—Video camera; 212—Communication Hub; 214—Router; 216—Antenna Tower; 218—Network; 220—Internet; 222—Computing device; 223—Mobile computing device; 224—Remote computing device; 226—Server; 228—Controller; 230—User interface; 232—Application; 234—Notification; 236—Lens; 238—Image sensor; 240—Processor; 241—Image processor; 242—Storage medium; 400—Method for monitoring and determining consumption; 402—Animal approaching: 404—Animal coming into view; 406—Animal consuming; 408—Data collection method; 409—Visual data collection method; 410—Converting images; 412—Determining liquid consumption: 414—Initiating video stream; 416—Video acquisition; 418—Processing video stream; 420—Event determination; 422—Animal identification; 424—Storage; 426—Swallow detection model; 428—Volume detection model; 430—Volume remaining model; 432—Refill estimate model; 434—Consumption trend model; 436—Notification model; 500—Pet profile database; 502—Animal image; 504—Identifier ID; 506—Animal name; 508—Species; 510—Breed: 512—Weight; 514—Date of birth; 516—Age

Unless otherwise stated, any numerical values recited herein include all values from the lower value to the upper value in increments of one unit provided that there is a separation of at least 2 units between any lower value and any higher value. As an example, if it is stated that the amount of a component, a property, or a value of a process variable such as, for example, temperature, pressure, time and the like is, for example, from 1 to 90, preferably from 20 to 80, more preferably from 30 to 70, it is intended that intermediate range values such as (for example, 15 to 85, 22 to 68, 43 to 51, 30 to 32 etc.) are within the teachings of this specification. Likewise, individual intermediate values are also within the present teachings. For values that are less than one, one unit is considered to be 0.0001, 0.001, 0.01, or 0.1 as appropriate. These are only examples of what is specifically intended, and all possible combinations of numerical values between the lowest value and the highest value enumerated are to be considered to be expressly stated in this application in a similar manner.

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

The terms “generally” or “substantially” to describe angular measurements may mean about +/−10° or less, about +/−5° or less, or even about +/−1° or less. The terms “generally” or “substantially” to describe angular measurements may mean about +/−0.01° or greater, about +/−0.1° or greater, or even about +/−0.5° or greater. The terms “generally” or “substantially” to describe linear measurements, percentages, or ratios may mean about +/−10% or less, about +/−5% or less, or even about +/−1% or less. The terms “generally” or “substantially” to describe linear measurements, percentages, or ratios may mean about +/−0.01% or greater, about +/−0.1% or greater, or even about +/−0.5% or greater.

The disclosures of all articles and references, including patent applications and publications, are incorporated by reference for all purposes. The term “consisting essentially of” to describe a combination shall include the elements, ingredients, components, or steps identified, and such other elements ingredients, components, or steps that do not materially affect the basic and novel characteristics of the combination. The use of the terms “comprising” or “including” to describe combinations of elements, ingredients, components, or steps herein also contemplates embodiments that consist essentially of, or even consist of the elements, ingredients, components, or steps. Plural elements, ingredients, components, or steps can be provided by a single integrated element, ingredient, component, or step. Alternatively, a single integrated element, ingredient, component, or step might be divided into separate plural elements, ingredients, components, or steps. The disclosure of “a” or “one” to describe an element, ingredient, component, or step is not intended to foreclose additional elements, ingredients, components, or steps.

It is understood that the above description is intended to be illustrative and not restrictive. Many embodiments as well as many applications besides the examples provided will be apparent to those of skill in the art upon reading the above description. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventors did not consider such subject matter to be part of the disclosed inventive subject matter.

What is claimed is:

1. A method for monitoring and determining consumption from a water dispenser by an animal executed by a visual monitoring system, the method comprising:
a) the animal approaching the water dispenser and coming into a view of a visual monitoring device, wherein the water dispenser includes a serving bowl for presenting a liquid for consumption and the visual monitoring device is affixed or part of the water dispenser and located above the serving bowl;
b) the animal consuming a liquid from a serving area of the water dispenser;
c) the visual monitoring device automatically capturing incoming image(s) of the animal consuming the liquid and converting the incoming image(s) to incoming image data, wherein the incoming image data includes:
i) at least a portion of a face and/or a neck of the animal visually indicating the animal is consuming the liquid;
ii) a number of laps while the animal is consuming the liquid from the serving area;
iii) a start time at which the animal begins to consume the liquid; and
iv) an end time at which the animal completes consuming the liquid; and
d) automatically determining an amount of the liquid consumed by the animal based on the incoming image data.

2. The method of claim 1, wherein the water dispenser includes a reservoir within an interior of the water dispenser for holding at least some of the liquid.

3. The method of claim 1, wherein the water dispenser includes one or more tanks for holding at least some of the liquid.

4. The method of claim 1, wherein the image data further includes sound associated with the animal consuming the liquid.

5. The method of claim 1, wherein the incoming image data is automatically evaluated by one or more processors by executing a total lap model to determine a total number of laps and/or other swallowing actions from the start time to the end time.

6. The method of claim 1, wherein the incoming image data includes the at least a portion of the face and/or neck of the animal visually indicating the animal is consuming the liquid.

7. The method of claim 2, wherein the at least a portion of the face and/or neck includes a tongue of the animal.

8. The method of claim 1, wherein the number of laps includes:
a number of occurrences over a period of time a mouth and/or the neck of the animal indicate(s) a swallowing of the liquid; and/or
a number of occurrences over a period of time a tongue laps the liquid in order to consume the liquid.

9. The method of claim 1, wherein the visual monitoring device includes one or more image sensors.

10. (canceled)

11. The method of claim 101, wherein the automatically determining the amount of the liquid consumed by the animal includes the number of laps of the animal consuming the liquid during a single visit to the water dispenser; and
wherein optionally, the number of laps during the single visit is determined as a laps per second and/or other rate measurement.

12. The method of claim 11, wherein the automatically determining the amount of liquid consumed by the animal is also based on an identification of the animal; and
wherein the identification of the animal includes identifying the animal by a genus, species, breed, weight, size, gender, age, or a combination thereof.

13. The method of claim 12, wherein the identification is a result of automatically executing visual recognition.

14. The method of claim 12, wherein the identification is determined from one or more identification sensors associated with the water dispenser detecting one or more identifiers; and
wherein the one or more identifiers are correlated to a specific identity of the animal; and
wherein the one or more identification sensors and the one or more identifiers are configured for communication with one another via Bluetooth, Wi-Fi, Radiofrequency Identification, Near Field Communication, or any combination thereof.

15-16. (canceled)

17. The method of claim 12, wherein the identification of the animal is utilized to determine an average volume of consumption per lap or swallowing action.

18. The method of claim 1, wherein the visual monitoring system determines an average volume of consumption per lap and/or swallowing action by an actual view of the amount of the liquid being consumed per lap by the animal.

19. The method of claim 1, wherein the method includes one or more mass sensors or volume sensors detecting a change in mass or volume of the liquid in the water dispenser over a predetermined time period.

20. The method of claim 19, wherein the method includes determining a volume reduction as the change in the mass or the volume during the predetermined time period.

21. The method of claim 20, wherein the method includes correlating the volume reduction during the predetermined time period to the number of laps during the same predetermined time period to determine a fixed constant value.

22. The method of claim 21, wherein the fixed constant value is the volume reduction during the predetermined time period divided by the number of laps during the same time period.

23. The method of claim 21, wherein the automatically determining the amount of the liquid consumed includes multiplying the fixed constant value by the number of laps by the animal detected during a subsequent predetermined time period, single consumption visit, or both.

24. The method of claim 1, wherein the method includes automatically determining an amount of fresh liquid available in the water dispenser, an estimate of when the fresh liquid will be depleted, or both based on the-a determined amount of the liquid consumed by the animal.

25. The method of claim 24, wherein the method includes determining when a user has filled a tank of the water dispenser.

26. The method of claim 25, wherein the determining when the user has filled the tank is automatic based on a detected mass change of the water dispenser and/or a detected volume change within the tank; and/or
wherein the user inputs an action of filling the tank into a user interface of a computing device, and optionally, also inputs a volume of fresh liquid added into the tank.

27. (canceled)

28. The method of claim 1, wherein the incoming image(s) and/or the incoming image data include one or more videos, images, frames, or any combination thereof.

29-89. (canceled)
